(19) United States
(12) Patent Application Publication
(10) Pub. No.: US 2007/0272164 A1
(43) Pub. Date: Nov. 29, 2007

(54) Liquid applicator for livestock

(76) Inventor: Fred W. Mann, Waterville, KS (US)

Correspondence Address: MARK BROWN, 4700 BELLEVIEW SUITE 210, KANSAS CITY, MO, 64112, US

(21) Appl. No.: 11/439,922

(22) Filed: May 24, 2006

(51) Int. Cl. A01K 5/01

(52) U.S. Cl. 119/72

(57) ABSTRACT

A liquid applicator for livestock comprises a combination of a liquid applicator assembly and a feeder assembly. The liquid applicator assembly includes a cover with a weather-impervious upper layer and a liquid-permeable, absorbent lower layer. A liquid reservoir communicates with the cover lower layer for saturating same with liquid, such as pesticide. The feeder assembly provides a support for the cover.

### BACKGROUND OF THE INVENTION

1. Field of the Invention

The present invention relates generally to livestock treatment, and in particular to an apparatus for applying liquid, such as pesticides, to livestock.

2. Description of the Related Art

In the field of animal husbandry, livestock commonly require treatment for controlling various pests, insect larvae, infestations, infections and other potentially harmful and contagious conditions. Liquid bases are commonly used as the delivery carriers for medications and pesticides. Such medications are also available as powders, which can be applied with various dusting devices. For example, the Dusticator™ device is available from Mann Enterprises, Inc. of Waterville, Kans. and includes a livestock feeder combined with porous bags of powdered insecticide, which “dust” the livestock as they are feeding. See, for example, Mann U.S. Pat. No. 3,941,096 and No. 4,023,533.

The liquid compositions can be poured directly onto the livestock for topical applications. However, combining a medication or insecticide delivery system with a feeder or mineral dispenser has several advantages. Such equipment can operate automatically to treat entire herds of livestock without human intervention. Cattle and other animals requiring such treatments seek access to feed, water and minerals, such as salt blocks, on a regular and frequent basis. Preferably medications can be applied while the animals are in the process of consuming feed, minerals, water, etc. In this manner the livestock are essentially voluntarily medicating themselves without any need for individual treatment or attention from the ranch operators.

It would also be preferable for such liquid applicators to be adaptable to various configurations of feeders, waterers and mineral dispensers. Another preferred feature provides for storing a supply of medication whereby multiple applications can be made between replenishments. Such applicators should also be sufficiently rugged to withstand abuse by livestock, exposure to the elements and extremes of temperature associated with permanent field placement.

Heretofore there has not been available an applicator for applying insecticide and medications to multiple head of livestock with the advantages and features of the present invention.

### BRIEF DESCRIPTION OF THE INVENTION

In the practice of an aspect of the present invention, a liquid applicator is provided for topically and automatically applying liquid to multiple head of livestock. The liquid application can be in conjunction with, for example, consuming feed, water and minerals. A receptacle assembly is provided and includes a flexible cover, with an upper layer impervious to the weather and a lower, highly absorbent layer adapted for direct contact with the heads of the livestock as they are eating from the feeder. A liquid reservoir can optionally be provided for automatically and continuously replenishing the liquid saturating the lower layer of the cover.

### BRIEF DESCRIPTION OF THE DRAWINGS

FIG. 1 is a top plan view of a liquid applicator comprising an aspect of the present invention, shown as a cover assembly for a mineral dispenser.

FIG. 2 is a cross-sectional view thereof, taken generally along line 2-2 in FIG. 1.

FIG. 3 is an enlarged, fragmentary, cross-sectional view thereof, taken generally within circle 3 in FIG. 2.

FIG. 4 shows a modified aspect thereof with an extended reservoir.

FIG. 5 shows another modified aspect thereof mounted on a different mineral or feed receptacle.

FIG. 6 is a cross-sectional view thereof, taken generally along line 6-6 in FIG. 5.

FIG. 7 is an enlarged, cross-sectional view thereof, particularly showing a liquid reservoir.

FIG. 8 is an enlarged plan view of a split washer thereof, taken generally along line 8 in FIG. 7.

FIG. 9 is a cross-sectional view of a modified aspect thereof, adapted for mounting on a livestock mineral feeder manufactured by Bower Equipment of Houghton, Iowa.

FIGS. 10 and 11 are cross-sectional views of other modified aspects of the invention.

FIG. 12 is a front elevational view of another modified aspect of the invention.

FIG. 13 is a side elevational view thereof.

FIG. 14 is an enlarged, fragmentary, cross-sectional view thereof, taken generally along line 14 in FIG. 12.

FIGS. 15-19 show alternative embodiment covers for applying liquids and other substances to livestock coming into contact there with.

### DETAILED DESCRIPTION OF THE PREFERRED EMBODIMENTS

I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning. The invention can be fabricated in various sizes and configurations from a wide variety of suitable materials, which are chosen for their characteristics according to the intended use and the operation of the invention.

II. Liquid Applicator for Livestock

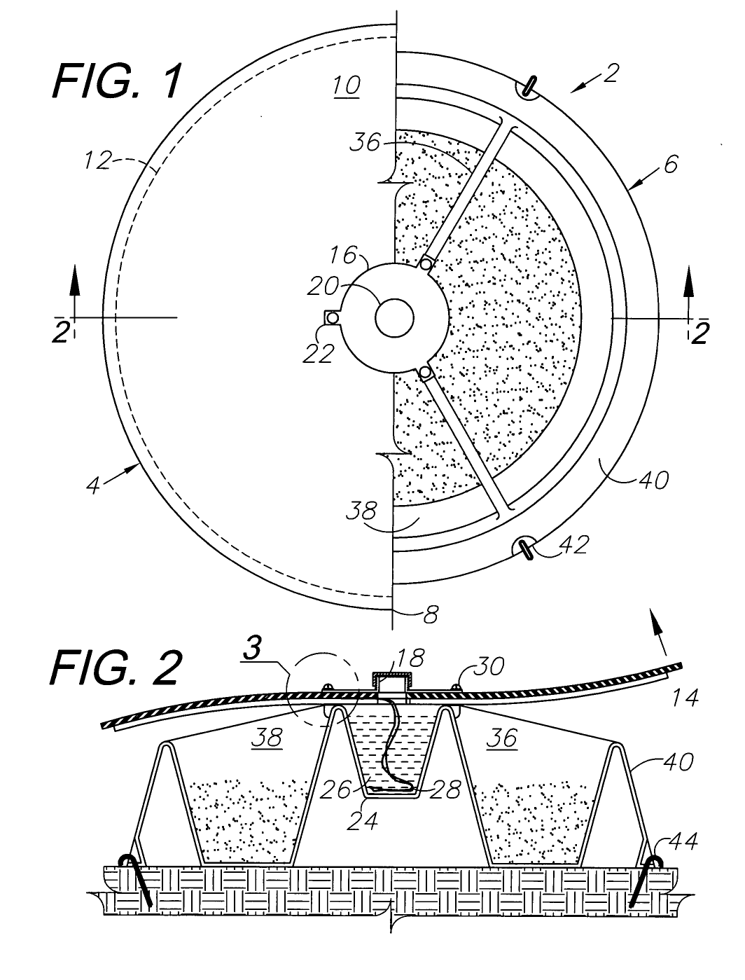

Referring to the drawings in more detail, the reference numeral 2 generally designates a combination liquid applicator assembly 4 and mineral feeder assembly 6 embodying an aspect of the present invention, as shown in FIGS. 1-3. The applicator assembly 4 includes a flexible cover 8 with an upper, weather-impervious layer 10 comprising, e.g., masticated rubber and a lower, liquid-permeable layer 12 comprising, e.g., polypropylene felt. The upper layer 10 is slightly larger than the lower layer 12, providing a slight perimeter overhang 14. A top plate 16 includes a center filler hole 18 closed by a filler cap 20 and multiple (e.g., three are shown) radially-extending mounting tabs 22.

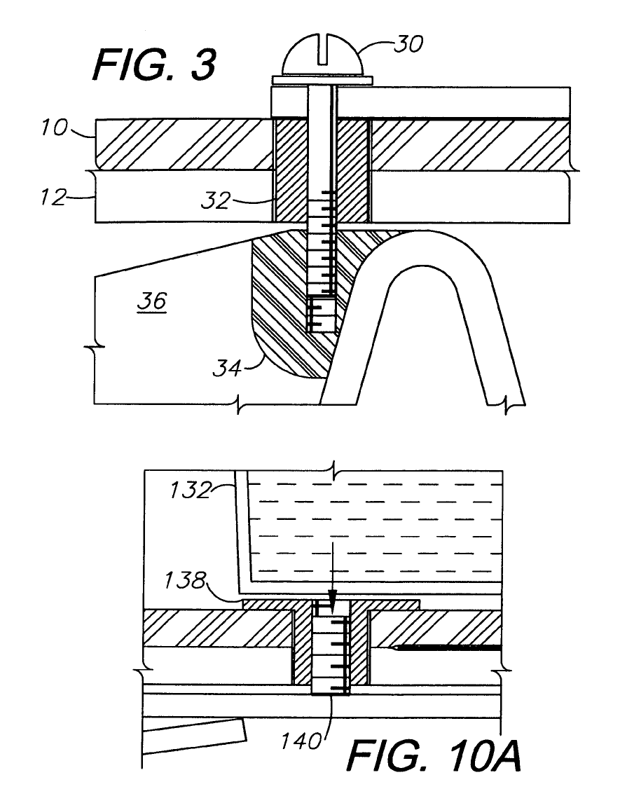

A center reservoir 24 is formed integrally with the feeder assembly 6 and receives liquid 26 through the center filler hole 18. The feeder assembly 6 can be similar to the feeder assemblies shown in Mann U.S. Pat. No. Des. 347,303, which is incorporated herein by reference, with the addition of the center reservoir 24. A sidewall 40 of the combination liquid applicator and feeder 2 extends further out (i.e. to the edge of the base rim) than the construction shown in the design patent for greater mineral and feed capacity. A wick 28 comprising an absorbent, wicking material extends into the reservoir 24 and engages the absorbent lower layer 12 of the cover 8 for maintaining a saturating flow of liquid 26 at a controlled rate. The cover 8 is mounted on the feeder assembly 6 by multiple fasteners 30, e.g., screws, threadably extending through internally-threaded, cylindrical spacers 32 and into internally-threaded bosses 34 (FIG. 3), which are molded into radial, vertical dividers 36 of the feeder assembly 6, forming mineral feeder compartments 38 adapted for receiving various materials comprising livestock feed and/or minerals. The outer sidewall 40 terminates at a base 42 adapted for ground attachment with stakes 44. In operation, the liquid distribution rate can be controlled by the height of the spacers 32. Shorter spacers 32 allow greater compression of the cover 8, thus restricting liquid flow. Conversely, taller spacers 32 facilitate greater fluid flow rates. Loosening the screws 30 can likewise have the effect of increasing liquid flow.

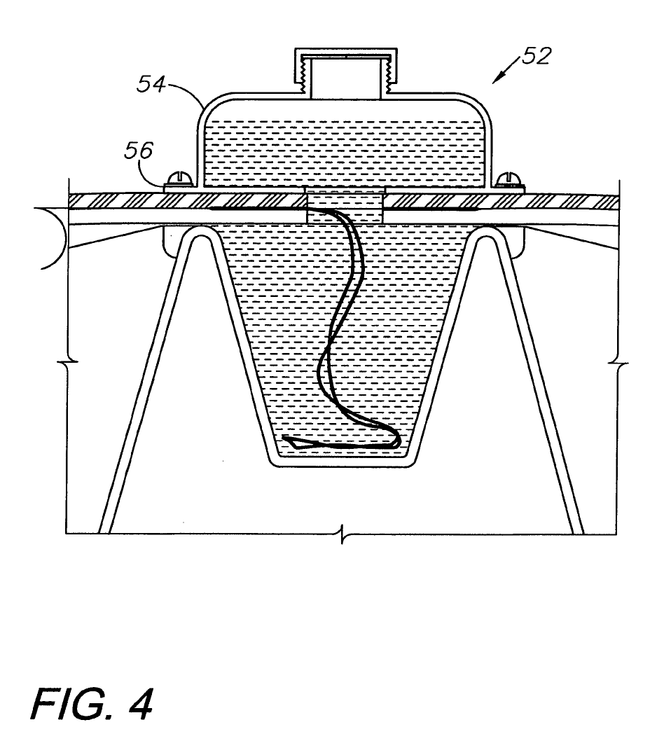

FIG. 4 shows a combination liquid applicator and feeder 52 comprising a modified aspect of the invention and including a reservoir extension 54 mounted on and extending upwardly from a top plate 56.

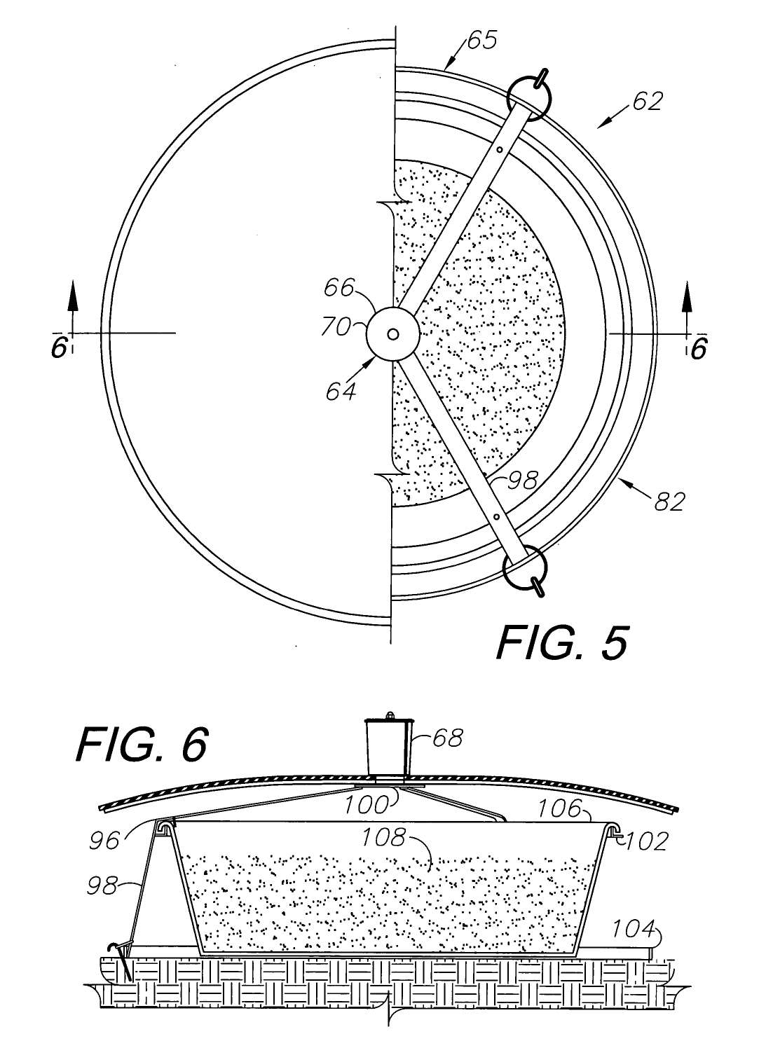

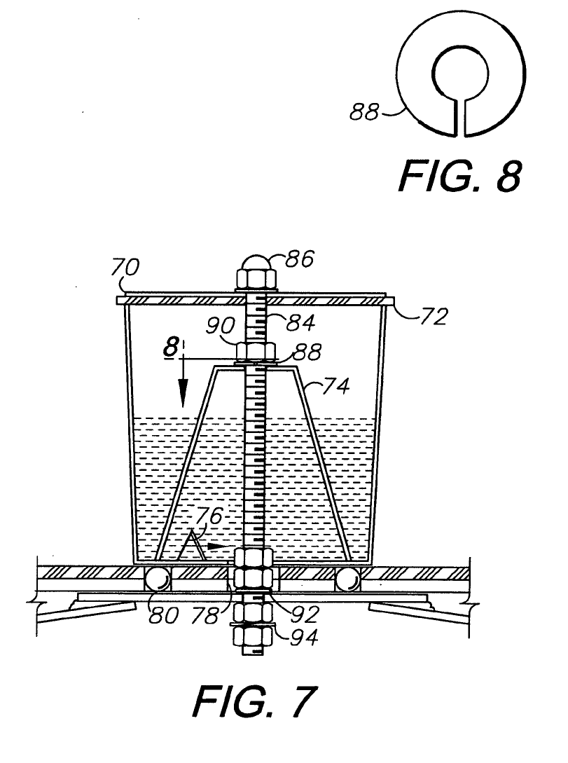

FIGS. 5-8 show a combination liquid applicator and mineral feeder 62 comprising another modified aspect of the invention and including a liquid applicator assembly 64 and a feeder assembly 65. The liquid applicator assembly 64 includes a reservoir 66 (FIG. 7) with a canister 68 enclosed by a lid 70 with a lid gasket 72. A pressure cone 74 is mounted in the canister 68 and includes a lower passage 76 through which the liquid 26 passes for exiting an outlet port 78 in the bottom of the canister 68 for absorption and distribution by the absorbent, lower layer 12 of the cover 8. The pressure cone 74 tends to equalize the liquid pressure at the outlet port 78 for even distribution with different levels of liquid 26 in the canister 68. Spacers 80 mounted in the cover 8 below the reservoir 66 can comprise steel balls or other suitable shapes, such as the cylindrical spacers 32. Steel balls are available in multiple diameters with small incremental differences, whereby considerable control of the liquid flow rate can be accomplished by varying the diameters of the steel balls 80.

The reservoir 66 and the cover 8 can be mounted on a mineral feeder assembly 82 by a continuously-threaded rod 84, which secures the lid 70 by an acorn nut 86 and the pressure cone 74 by a nut 90 and a slotted washer 88 (FIG. 8) adapted for ventilating the pressure cone 74. A pair of nuts 90 is provided over a sealing O-ring 92 in the outlet port 78. Another pair of nuts 90 and a lock washer 94 between the nuts 90 are mounted on the threaded rod 84 in proximity to its lower end below the cover 8 whereby the liquid applicator assembly 64 is mounted on the feeder assembly 65.

The feeder assembly 65 can be similar to the livestock feeder shown in Mann U.S. Pat. No. 5,630,375, which is incorporated herein by reference. A frame subassembly 96 includes multiple (e.g., three are shown) legs 98 radiating outwardly from a frame center plate 100 to a tub support ring 102 and downwardly to a base ring 104. The pairs of nuts 90 are adapted for securely attaching the threaded rod 84 to the frame center plate 100, with the O-ring 92 providing a liquid seal whereby the liquid 26 is diverted outwardly to the cover absorbent layer 12. A tub 106 is mounted on the frame subassembly 96 and can receive minerals 108, such as a salt block, feed or both.

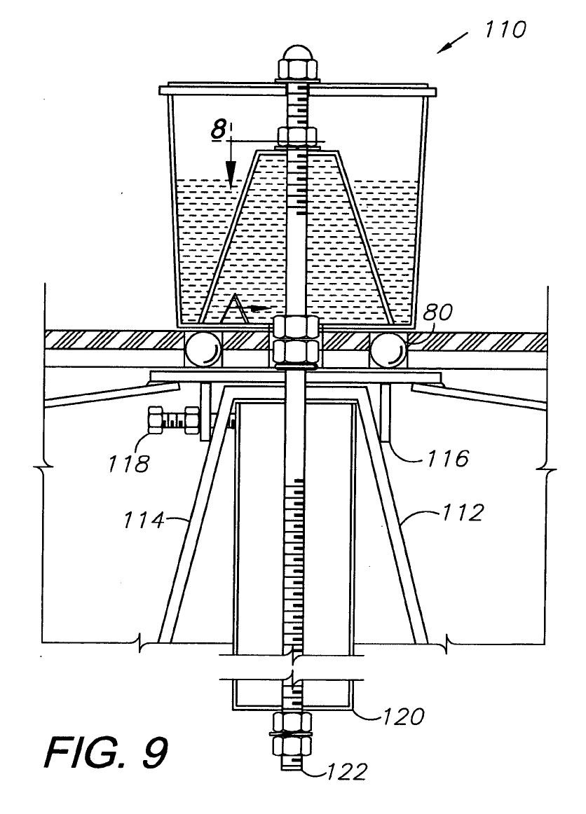

FIG. 9 shows another aspect of the invention with a modified applicator assembly 110 adapted for mounting on a mineral feeder 112 available from Brower Equipment of Houghton, Iowa and including a central cone 114. The applicator assembly 110 includes an annular mounting ring 116 with a set screw 118 adapted for penetrating the upper end of the Brower mineral feeder cone 114 and engaging a tubular extension 120, which projects downwardly within the cone 114 to provide access to a lower pair of nuts 90, which are received on a threaded rod 122. Similar feeders are shown in Mann U.S. Pat. No. Des. 347,303, and could be fitted with a liquid applicator assembly similar to the applicator assembly 110.

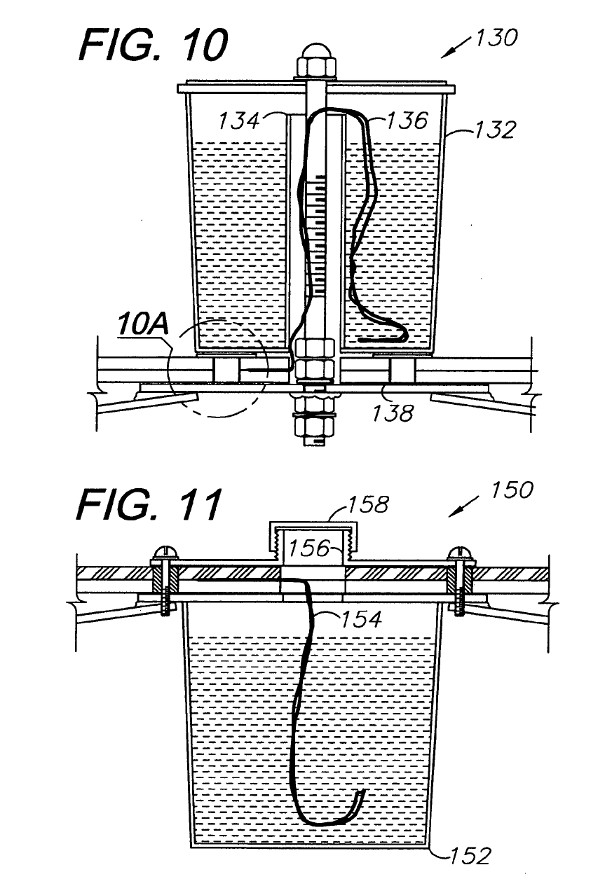

FIGS. 10 and 10A show a liquid applicator 130 comprising another aspect of the invention with a reservoir 132 mounted on the cover 8, which in turn is mounted on the frame center plate 100 of the frame assembly 96, as described above and as shown in Mann U.S. Pat. No. 5,630,375. The reservoir 132 includes an overflow tube 134, which receives a wick 136 located within the reservoir 132 for immersion in the liquid 26, which is transferred by a wicking action to the absorbent lower layer 12. FIG. 10A shows a spacer 138 comprising a weld nut and extending through the cover 8 between the reservoir 132 and the frame center plate 100 for controlling the flow rate by means of an adjustable set screw 140, shown extending slightly downwardly from the spacer 138. Extending the set screw 140 tends to increase the liquid flow rate and vice versa.

FIG. 11 shows a liquid applicator 150 comprising another aspect of the invention and including a reservoir 150 mounted on the underside of the frame center plate 100 and receiving a wick 154. A filler hole 156 is provided in the center plate 100 and is selectively closed by a filler cap 158.

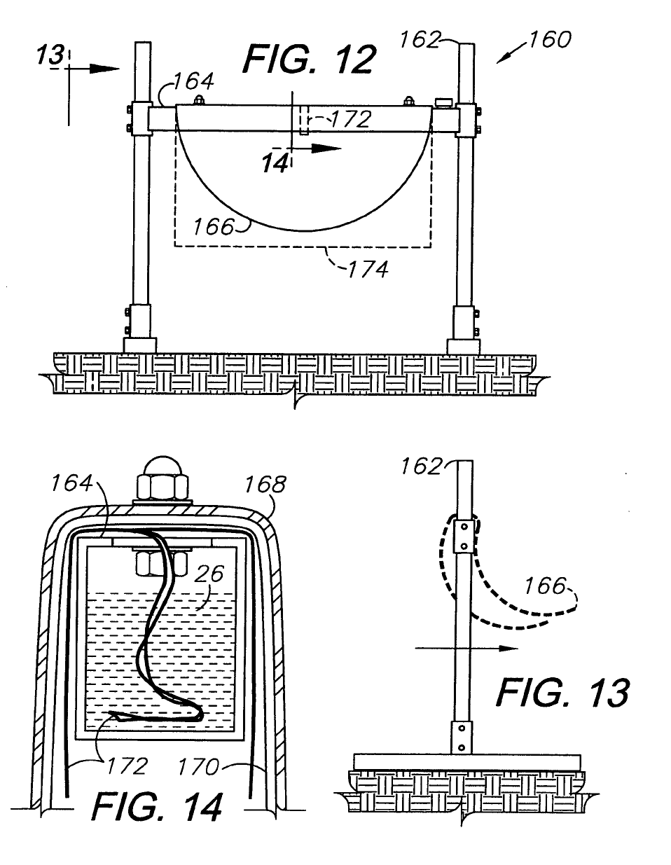

FIGS. 12-14 show a liquid applicator 160 comprising an H-frame assembly 162 with a hollow, tubular crosspiece comprising a reservoir 164. A cover 166 including an upper, weather-impervious layer 168 and a lower, liquid-permeable, absorbent layer 170 is draped over the crosspiece reservoir 164 and receives the liquid 26 therefrom through wicks 172. In addition to a circular cover 166 as shown in FIG. 12, a cover 174 with a rectangular configuration could be provided, as shown by the broken lines in FIG. 12. The liquid applicator 160 can be used as a barrier through which livestock must pass for access to, for example, feed and/or minerals. Multiple applicators 160 can be grouped in various combinations to guide livestock, which can pass through them or pass alongside them for application of the liquid 26 through contact. For example, a chute can be formed with sidewalls comprising multiple applicators 160 and livestock can be guided therethrough for liquid application to their sides through direct contact with the cover lower layers 170. Multiple applicators 160 can also be arranged in a circle or other enclosing configuration around a feeder or other device, whereby livestock must pass through the applicators 160 for access to the feed or minerals contained in the feeder positioned in the center of the enclosure. As an alternative or in addition to the cover 166, multiple wick material strips 172 can be suspended from the crosspiece reservoir 164 in communication with the liquid 26 therein for engagement by livestock passing alongside or through the applicators 160.

It is to be understood that the invention can be embodied in various forms, and is not to be limited to the examples discussed above. Other components and configurations can be utilized in the practice of the present invention. For example, the liquid reservoir can be omitted and the liquid 26 can be manually poured onto the cover lower layer 12 as required. The feeder assemblies can be molded with tapered configurations adapted for for nesting in order to conserve for shipping and storage purposes. Moreover, rotational molding techniques can be utilized for molding two feeder assemblies joined at their bases in one mold, for separation after completion of the molding process. Other manufacturing and fabrication techniques can likewise be used to advantage.

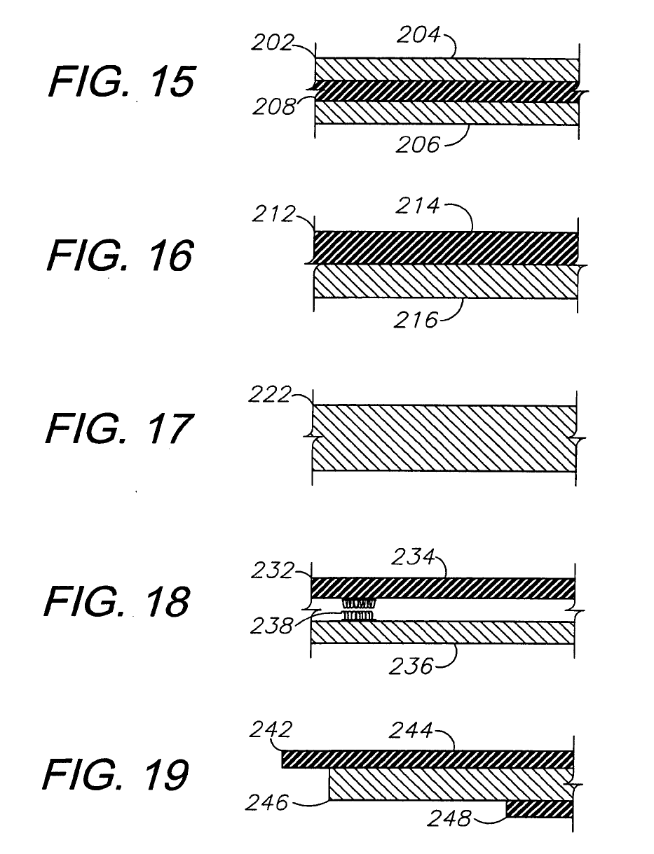

An alternative embodiment cover 202 shown in FIG. 15 and includes upper and lower felt layers 204, 206. A layer of urethane 208 is sprayed, brushed or otherwise applied to respective opposed surfaces of the felt layers 204, 206, which are then sandwiched together. The urethane 208 cures between the felt layers 204, 206. Livestock can contact either of the felt layers 204, 206 for application of liquid therefrom. Another alternative embodiment cover 212 is shown in FIG. 16 and includes an upper, urethane layer 214, which is sprayed, brushed or otherwise applied to a felt layer 216. Yet another alternative embodiment cover 222 is shown in FIG. 17 and comprises a single, monolithic material, such as felt, urethane, leather, etc. Such material can be saturated with insecticides, pharmaceuticals or other substances for application to and treatment of livestock. Another alternative embodiment cover 232 is shown in FIG. 18 and includes an upper, rubber layer 234 and a lower, felt layer 236, which can be secured together by suitable hook-and-loop fasteners 238, which can be sewn to the layers 234, 236. Still another alternative embodiment cover 242 is shown in FIG. 19 and includes an upper rubberized layer 244, which overhangs an intermediate, felt layer 246, which overhangs a lower rubberized layer 248 whereby respective wiping areas are defined by the overhangs. The covers can be freely rotatable with respect to the feeders and other support structures in order to enhance liquid application to livestock and to minimize cover damage. Moreover, various spoke and spider shaped structures can be installed under the covers for supporting same.

It is to be understood that the invention can be embodied in various forms, and is not to be limited to the examples discussed above. Other components and configurations can be utilized in the practice of the present invention.

1. A liquid applicator for livestock, which comprises:
a support structure;
a reservoir connected to the support structure and adapted for receiving a quantity of liquid therein;
a cover including a layer of wicking material;
said cover being mounted in overlying relation on said support structure and adapted for contacting livestock and applying liquid thereto; and
said cover wicking material layer being in fluidic communication with said reservoir.

2. The applicator according to claim 1, which includes:
a wick located in said reservoir and fluidically connected to said cover wicking material layer.
